(19) United States
(12) Patent Application Publication
(10) Pub. No.: US 2009/0122638 A1
(43) Pub. Date: May 14, 2009

(54) MIXING ELEMENTS OF STATIC MIXER

(75) Inventors: Kimihiko Sato, Itabashi-ku (JP); Masaaki Kaneko, Itabashi-ku (JP); Koichi Mamada, Itabashi-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: GC Corporation, Itabashi-ku (JP)

(21) Appl. No.: 12/266,833

(22) Filed: Nov. 7, 2008

(30) Foreign Application Priority Data
Nov. 9, 2007 (JP) 2007-292219

(51) Int. Cl. B01F 13/00

(52) U.S. Cl. 366/339

(57) ABSTRACT

To provide mixing elements of a Kenix type static mixer capable of decreasing fluids remaining wastefully in a casing without elongation of the casing, the mixing elements are arranged in a casing so that end parts adjacent in an axial direction are connected to cross almost orthogonally, the mixing element includes a partition wall part (1) in a thin flat plate shape for partitioning the casing into approximately equal cross sectional areas, and plural spiral blade parts (2, . . . ) having a shape of a thin plate twisted by approximately 180 degrees, and being positioned in spaces partitioned by the partition wall part (1), wherein outer peripheries of the spiral blade parts (2, . . . ) at the partition wall part (1) side are integrally contacted with the partition wall part (1), and outer peripheries of the spiral blade parts (2, . . . ) at the casing side are contacted with an inner wall of the casing.

### BACKGROUND OF THE INVENTION

1. Field of the Invention

The present invention relates to mixing elements of a Kenix type static mixer having spiral blades arranged in a casing. The spiral blades respectively have a shape twisted by approximately 180 degrees in an axial direction of the casing and end parts of the blades are connected so as to be almost orthogonally crossed.

2. Description of the Conventional Art

When fluids are mixed, a static mixer not having a driving part is widely used. For example, there exists a mixer having a cylindrical casing, mixing elements respectively having a clockwise spiral blade, and mixing elements respectively having a counterclockwise spiral blade. Both kinds of the mixing elements respectively have a shape twisted by approximately 180 degrees in an axial direction. End parts of adjacent spiral blades are connected so as to cross almost orthogonally and both kinds of the mixing elements are alternately arranged in the axial direction (Refer to U.S. Pat. No. 3,953,002 and U.S. Pat. No. 4,408,893 for example).

Such the static mixer is generally called as a Kenix type static mixer. Two separated spiral flowing passages are formed with the twisted spiral blades (the mixing elements) arranged in a casing and an inner wall of the casing, and fluids pass through these flowing passages so as to be divided into two. In the Kenix static mixer, such the division is repeated, and thus a mixed state can be made.

However, since the fluids are divided only into two by every mixing element, many mixing elements are necessary in order to sufficiently divide and make a mixed state. For example, when the fluids are divided into 1000 or more, about 10 to 12 mixing elements (to divide the fluids into 1024 (210) to 4096 (212)) are necessary. Therefore, in the conventional Kenix type static mixer, there are disadvantages that many mixing elements must be arranged in a casing so as to make it in an elongated size, and much fluids remain in the casing after use, which is wasteful.

On the other hand, there is a so-called SMX type static mixer having a plurality of mixing elements in a casing. Each mixing element consists of comb-shaped discs provided with slits and the discs cross with each other at these slit portions (Refer to U.S. Pat. No. 4,062,524 for example). The SMX type static mixer has many flow inlets formed at a portion where the comb-shaped slits in the discs are crossed. Thus, since fluids can be divided into many only by providing fewer mixing elements in comparison with the Kenix type static mixer, the size is not elongated.

However, for the SMX type static mixer, it is necessary that the comb-shaped slits are formed in the discs constituting the mixing element and the discs are arranged in the casing in the state that the discs are crossed. Thus, a comparatively large casing is necessary, so that the disadvantage that much fluids remain in the casing is not solved. Further, in the SMX type static mixer, fluids tend to follow straight, since they only pass through small flow inlets formed at the crossing part of the slits. Thus, there is a disadvantage that mixing performance is lower than the Kenix static mixer in which fluids pass through the spiral flowing passage.

### SUMMARY OF THE INVENTION

### Problem to be Solved by the Invention

The present invention is made to solve these problems, and an objective of the present invention is to provide mixing elements of a Kenix type static mixer, which is not elongated in a size of the casing and is thus capable of decreasing fluids remaining in the casing wastefully.

### Means for Solving the Problem

Present inventors carried out earnest works to solve the above-described problems and, as a result they found out the followings to complete the present invention. Mixing elements of a static mixer are arranged in a casing so that their end parts adjacent in an axial direction of a casing having a cylindrical or square tube shape are connected so as to be almost orthogonally crossed. Each of the mixing elements includes a partition wall part having a thin flat plate shape, and a plurality of spiral blade parts. The partition wall part partitions a cross section of the casing so as to have approximately equal areas when the mixing element is provided in the casing. The spiral blade parts respectively have a shape in which a thin plate is twisted by approximately 180 degrees toward an axial direction of the casing, and outer peripheries of the spiral blade parts at the partition wall part side are integrally contacted with the partition wall part. The spiral blade parts are respectively positioned in each space partitioned by the partition wall part in the casing, and outer peripheries of the spiral blade parts at the casing side are contacted with an inner wall of the casing along the whole length of each space. In a conventional Kenix type static mixer, fluids are divided into two by every mixing element. However, according to the invention, since each mixing element has a plurality of spiral blade parts, one mixing element can make division into many. Thus, since many mixing elements are not necessary, the size of the casing is not elongated. Further, in a conventional Kenix static mixer, since the two separated flowing passages are formed between the spiral blade parts and the inner wall of the casing, the fluids flowing in the respective passages are not mixed during flow. Then, if a plurality of spiral blade parts are merely arranged in order to make it possible to divide fluids into many by one mixing element, the fluids are mixed between adjacent spiral blade parts. Thus, there occurs a new problem that an effect to divide fluids into many by arranging a plurality of the spiral blade parts is lost. However, the mixing element according to the present invention is formed to have the structure that the partition wall part in a thin flat plate shape to partition the cross section of the casing so as to have approximately equal areas is integrated with each spiral blade part. Therefore, since a plurality of the spiral blade parts form separated flowing passages with not only the inner wall of the casing but also the partition wall part, divided fluids are not mixed during flow. Furthermore, since the partition wall part is to partition the cross section of the casing so as to have approximately equal areas, an amount of fluids divided by each spiral blade part is equal. Thus, the fluids flowing in the casing can be well mixed.

That is, the present invention is mixing elements of a static mixer, which are arranged in a casing so that their end parts adjacent in an axial direction of the casing having a cylindrical or square tube shape are connected so as to be almost orthogonally crossed. The mixing element of a static mixer includes a partition wall part having a thin flat plate shape, and a plurality of spiral blade parts. The partition wall part partitions a cross section of the casing so as to have approximately equal areas when the mixing element is provided in the casing. The spiral blade parts respectively have a shape in which a thin plate is twisted by approximately 180 degrees toward an axial direction of the casing, and outer peripheries of the spiral blade parts at the partition wall part side are integrally contacted with the partition wall part. The spiral blade parts are respectively positioned in each space partitioned by the partition wall part in the casing, and outer peripheries of the spiral blade parts at the casing side are contacted with an inner wall of the casing along the whole length of each space.

Further, while the mixing element according to the present invention includes a plurality of spiral blade parts, clockwise and counterclockwise spiral blade parts can be mixedly used in one mixing element. However, when all spiral blade parts of one mixing element are twisted in the same direction, it is easy to produce the mixing element. When the mixing elements in which all spiral blade parts of one mixing element are twisted in the same direction (e.g., in the clockwise direction) are arranged in the casing in a state that their end parts adjacent in an axial direction of the casing are connected so as to be almost orthogonally crossed, fluids are divided into many at one time in each mixing element, and thus mixing efficiency of fluids is high. However, when mixing elements having only clockwise spiral blade parts and mixing elements having only counterclockwise spiral blade parts are alternately connected, a rotating direction of fluids is reversed for every mixing element. Thus, stirring performance can be made high, so that such is preferable. Further, when the mixing element includes portions to engage the end parts at the end parts to be adjacent in an axial direction of the casing, it is not necessary to produce a set of mixing elements in which a plurality of mixing elements are integrally connected so as to have a length corresponding to the length of a casing. Instead, by engaging the adjacent end parts of the mixing elements, it is easy to produce a static mixer having a desired length in combination of various mixing elements according to an intended use. Thus, such is preferable.

### EFFECT OF THE INVENTION

The mixing elements according to the present invention are a mixing elements of a static mixer arranged in a casing so that end parts adjacent in an axial direction of a casing having a cylindrical or square tube shape are connected so as to be almost orthogonally crossed. The mixing element of a static mixer includes a partition wall part having a thin flat plate shape, and a plurality of spiral blade parts. The partition wall part partitions a cross section of the casing so as to have approximately equal areas when the mixing element is provided in the casing. The spiral blade parts respectively have a shape in which a thin plate is twisted by approximately 180 degrees toward an axial direction of the casing, and outer peripheries of spiral blade parts at the partition wall part side are integrally contacted with the partition wall part. The spiral blade parts are respectively positioned in each space partitioned by the partition wall part in the casing, and outer peripheries of the spiral blade parts at the casing side are contacted with an inner wall of the casing along the whole length of each space. In a conventional Kenix type static mixer, fluids are divided into two by every mixing element. However, as for the mixing element according to the present invention, since each mixing element has a plurality of spiral blade parts, the fluids can be divided into many at one time. Thus, since many mixing elements are not necessary, the size of the casing is not elongated. Further, the mixing element according to the present invention is formed to have the structure that the partition wall part in a thin flat plate shape to partition the cross section of the casing so as to have approximately equal areas is integrated with each spiral blade part. Therefore, since a plurality of the spiral blade parts form separated flowing passages having equal cross sections with the inner wall of the casing and the partition wall part, divided fluids are not mixed during flow, and fluids can be equally divided by only using a few mixing elements. Thus, fluids wastefully remaining in a casing after use can be decreased.

Further, when the mixing elements in which all spiral blade parts of one mixing element are twisted in the same direction (e.g., in the clockwise direction) are arranged in the casing in a state that the end parts adjacent in an axial direction of the casing are connected so as to be almost orthogonally crossed, fluids are divided into many at one time in each mixing element, and thus mixing efficiency of fluids is high. However, when mixing elements having only clockwise spiral blade parts and mixing elements having only counterclockwise spiral blade parts are alternately connected, a rotating direction of fluids is reversed for every mixing element. Thus, stirring performance can be made high. Further, when the mixing element includes portions for engaging the end parts at the end parts to be adjacent in an axial direction of the casing, it is not necessary to produce a set of mixing elements in which a plurality of mixing elements are integrally connected so as to have a length corresponding to have the length of a casing. Instead, by engaging these adjacent end parts of the mixing elements, it is easy to produce a static mixer having a desired length in combination of various mixing elements according to an intended use.

### BRIEF EXPLANATION OF DRAWINGS

FIG. 1 is a perspective view to illustrate one example of the mixing element according to the present invention.

FIG. 2 is a left side view of FIG. 1.

FIG. 3 is a plan view of FIG. 1.

FIG. 4 is a front view of FIG. 1.

FIG. 5 is a perspective view to illustrate another example of the mixing element according to the present invention having portions for engaging end parts at an end part thereof.

FIG. 6 is a perspective view to illustrate further another example of the mixing element according to the present invention.

FIG. 7 is a side view to illustrate a state that a plurality of mixing elements in FIG. 1 are connected and provided in a casing.

FIG. 8 is a side view to illustrate a state that a mixing element in FIG. 1, which is cut orthogonally to an axial direction of a casing, is provided at the inlet side of a casing.

### DETAILED DESCRIPTION OF PREFERRED EMBODIMENT

The mixing elements according to the present invention will be described in detail below with reference to the drawings.

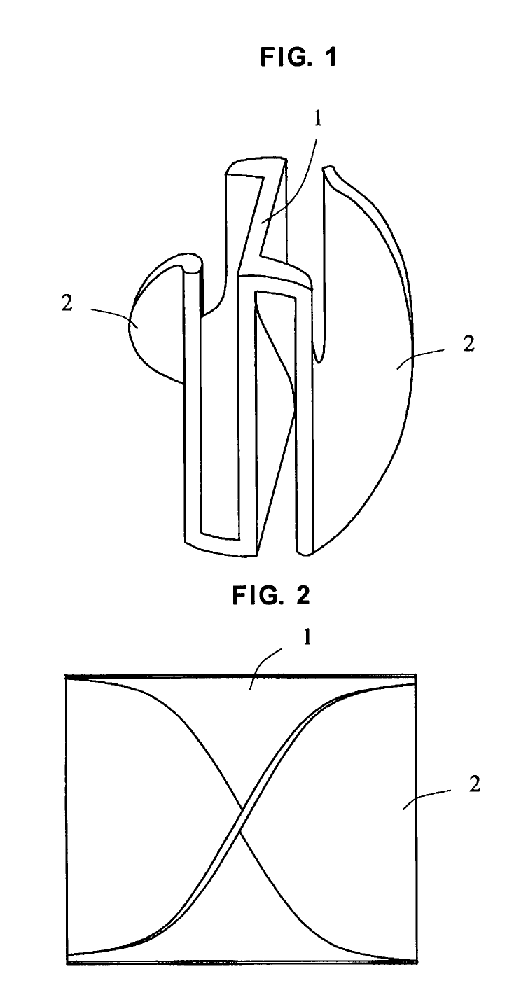

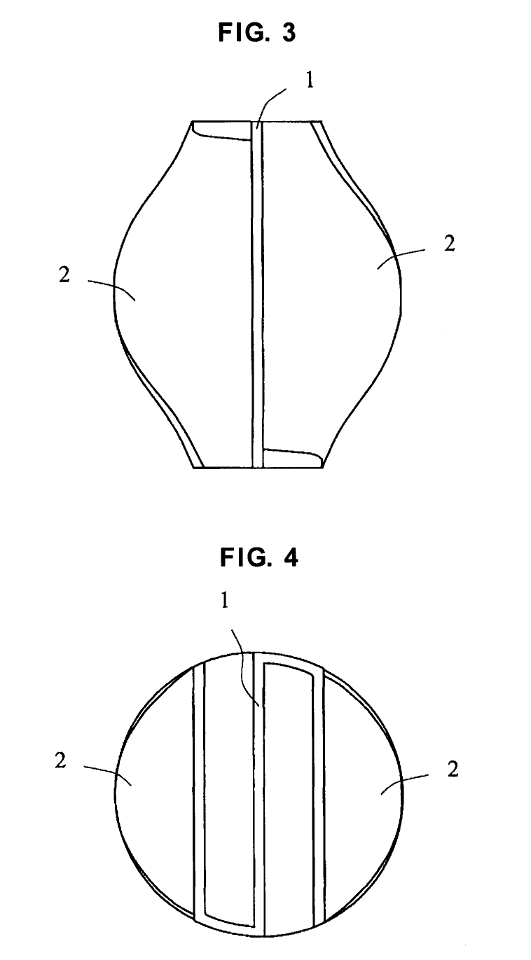

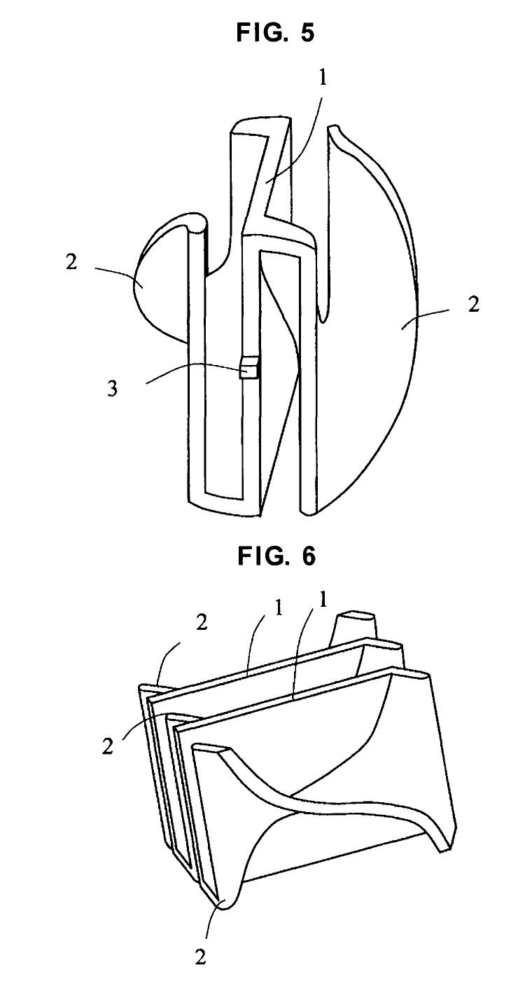

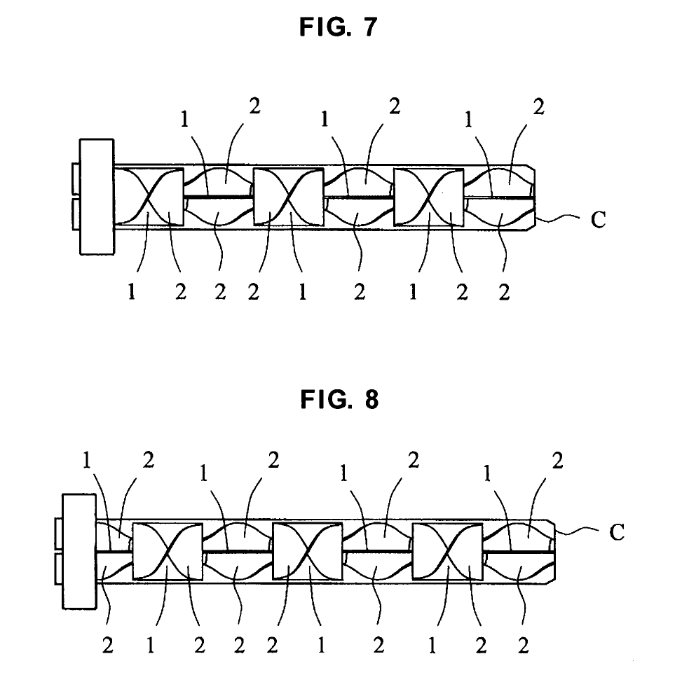

FIG. 1 is a perspective view to illustrate one example of the mixing element according to the present invention. FIG. 2 is a left side view of FIG. 1. FIG. 3 is a plan view of FIG. 1. FIG. 4 is a front view of FIG. 1. FIG. 5 is a perspective view to illustrate another example of the mixing element according to the present invention having portions for engaging end parts at an end part thereof. FIG. 6 is a perspective view to illustrate further another example of the mixing element according to the present invention. FIG. 7 is a side view to illustrate a state that a plurality of mixing elements in FIG. 1 are connected and provided in a casing. FIG. 8 is a side view to illustrate a state that a mixing element in FIG. 1, which is cut orthogonally to an axial direction of a casing, is provided at the inlet side of a casing.

A casing C in the drawings has a cylindrical tube shape or a square tube shape. Mixing elements according to the present invention are arranged in the casing C in a state that adjacent end parts of the mixing elements are connected so as to be almost orthogonally crossed. It is preferable that the casing C is transparent or semitransparent in order to observe the inside thereof, as illustrated in FIGS. 7 and 8.

A partition wall part 1 having a thin flat plate shape partitions a cross section of the casing C so as to have approximately equal areas when the mixing element is provided in the casing C. The cross section of the casing C is partitioned to have approximately equal areas by the partition wall part 1 in order to equally mix various kinds of fluids poured into the casing C. Further, in order to more equally mix various kinds of fluids, it is preferable that the cross section of the casing C is partitioned so as to have an approximately same shape, in addition to that the cross section of the casing C is partitioned so as to have an approximately equal area. For example, the mixing element as illustrated in FIGS. 1 to 4 is provided in the casing C having a cylindrical tube shape, and the partition wall part 1 is provided so as to make a circular cross section in the casing C to be semicircles respectively. Thus, since the cross section in the casing C is partitioned by the partition wall part 1 so as to have an approximately equal area and an approximately same shape, unevenness in mixing does not arise. Further, when the mixing element as illustrated in FIG. 6 is used in the casing C having a square tube shape, it is preferable that two partition wall parts 1 and 1 are provided so that a cross section in the casing C is partitioned so as to have equal areas and a same rectangular shape.

A spiral blade part 2 has a shape in which a thin plate is twisted by approximately 180 degrees toward an axial direction of the casing C, and an outer periphery of the spiral blade 2 at the partition wall 1 part side is integrally contacted with the partition wall part 1. Further, the spiral blade part 2 is positioned in each space partitioned by the partition wall part 1 in the casing C, and an outer periphery of the spiral part 2 at the casing C side is contacted with an inner wall of the casing C along the whole length of each space. The mixing element according to the present invention has a plurality of such the spiral blade parts 2, . . . . As for a conventional mixer, since one mixing element has only one spiral blade part, fluids are divided only into two. However, for example, when one mixing element of the present invention has two spiral blade parts 2 and 2, fluids are divided into four. Thus, since the same dividing number can be obtained by half numbers of the conventional mixing elements, an amount of fluids remaining in the casing C wastefully can be greatly decreased.

Further, in a conventional Kenix type static mixer, each mixing element has one spiral blade part, and stirring effect is obtained by alternately connecting mixing elements having a clockwise spiral blade part and mixing elements having a counterclockwise spiral blade part for reversing a rotating direction of fluids.

On other hand, the mixing element according to the present invention has a plurality of spiral blade parts 2, . . . . One mixing element can have mixedly clockwise and counterclockwise spiral blade parts 2 . . . . However, when the mixing elements having clockwise and counterclockwise spiral blade parts 2 . . . mixedly are connected so that end parts are almost orthogonally crossed, there occurs a case that a rotating direction of a part of fluids is not reversed at the end part of the mixing element, but is rotated in the same direction. Thus, stirring property may be deteriorated.

When all spiral blade parts 2 . . . of one mixing element are thus twisted in the same direction, it is easy to produce the mixing element. Further, when mixing elements having spiral blade parts 2, . . . all of which are twisted clockwise and mixing elements having spiral blade parts 2, . . . all of which are twisted counterclockwise are alternately connected, a rotating direction of fluids is reversed for every mixing element. Thus, since stirring performance can be made high, such is preferable.

Further, the mixing element according to the present invention may have a complicated shape since it includes the partition wall part 1 and a plurality of the spiral blade parts 2 . . . , so that it is hard to integrally form a plurality of such the mixing elements in a state of being connected. Therefore, mixing elements each of which has portions 3 for engaging end parts at the end parts to be adjacent in an axial direction of the casing C, as illustrated in FIG. 5 are separately produced. By connecting and fixing such the mixing elements, it becomes remarkably easy to produce mixing elements.

Further, when the mixing element includes the portions 3 for engaging the end parts, static mixers having various lengths according to intended uses can be easily produced. Thus, such is preferable.

In addition, as for the portions 3 for engaging the end parts, a prism-shaped small projection may be formed at a center part of the partition wall part 1 as illustrated in FIG. 5, and an engaging hole (not illustrated) to be engaged with the small projection may be formed at a center part of the partition wall part 1 at the opposite side to the small projection.

Furthermore, when high viscosity fluids are mixed, the fluids may not be smoothly divided at the inlet side of the casing C where the fluids are poured. In such the case, a mixing element which is cut in a direction orthogonal to an axial direction of the casing C may be provided at the inlet side of the casing C as illustrated in FIG. 8.

What is claimed is:

1. Mixing elements of a static mixer, which are arranged in a casing so that their end parts adjacent in an axial direction of the casing having a cylindrical or square tube shape are connected so as to be almost orthogonally crossed,
the mixing element comprising:
a partition wall part having a thin flat plate shape; and
a plurality of spiral blade parts,
wherein the partition wall part partitions a cross section of the casing so as to have approximately equal areas when the mixing element is provided in the casing, wherein the spiral blade parts respectively have a shape in which a thin plate is twisted by approximately 180 degrees toward an axial direction of the casing,
wherein outer peripheries of the spiral blade parts at the partition wall part side are integrally contacted with the partition wall part,
wherein the spiral blade parts are respectively positioned in each space partitioned by the partition wall part in the casing, and
wherein outer peripheries of the spiral blade parts at the casing side are contacted with an inner wall of the casing along the whole length of each space.

2. The mixing elements of a static mixer as claimed in claim 1, wherein all of the spiral blade parts are twisted in the same direction.

3. The mixing elements of a static mixer as claimed in claim 1, wherein the mixing element further includes portions for engaging the end parts adjacent in an axial direction of the casing.

4. The mixing elements of a static mixer as claimed in claim 2, wherein the mixing element further includes portions for engaging the end parts adjacent in an axial direction of the casing.
